(19) United States
(12) Patent Application Publication
(10) Pub. No.: US 2013/0293214 A1
(43) Pub. Date: Nov. 7, 2013

(54) Direct Current Converter for Bootstrap Circuit with predetermined charging duration

(71) Applicants: Shao-Te Chang, Yilan County (TW); Chun-Kai Hsu, New Taipei City (TW)

(72) Inventors: Shao-Te Chang, Yilan County (TW); Chun-Kai Hsu, New Taipei City (TW)

(21) Appl. No.: 13/542,682

(22) Filed: Jul. 6, 2012

(30) Foreign Application Priority Data
May 3, 2012 (TW) 101115774

(51) Int. Cl. G05F 3/08

(52) U.S. Cl. 323/311

(57) ABSTRACT

A direct current (DC) converter for converting an input voltage to an output voltage, includes a driving-stage circuit having an upper and a lower switch for converting the input current to a switch signal and transmitting the switch signal through an output terminal, an output-stage circuit coupled to the output terminal for converting the switch signal to the output voltage, a bootstrap circuit coupled between a bootstrap voltage terminal and the output terminal of the driving-stage circuit, a upper switch driving circuit for generating the upper switch control signal, and a control module for generating the upper and the lower switch control signal and controlling the upper switch driving circuit to generate the upper switch control signal according to a first and a second time duration, so as to timely switch the bootstrap circuit to a charge state accordingly.

### BACKGROUND OF THE INVENTION

1. Field of the Invention

The present invention relates to a direct current (DC) converter, and more particularly, to a DC converter capable of timely charging a bootstrap capacitor.

2. Description of the Prior Art

An electronic device includes various components, each of which may operate at different voltage levels. Therefore, a DC converter is definitely required to adjust (step up or down) and stabilize the voltage level in the electronic device. Originating from a buck (or step down) converter and a boost (or step up) converter, various types of DC converters are accordingly customized to meet different power requirements. As implied by the names, the buck converter is utilized for stepping down a DC voltage of an input terminal to a default voltage level, and the boost converter is for stepping up the DC voltage of the input terminal. With the advancement of modern electronics technology, both of the buck converter and the boost converter are modified and customized to conform to different architectures or to meet different requirements.

For example, please refer to FIG. 1, which is a schematic diagram of a conventional DC converter 10. The DC converter 10 includes a driving-stage circuit 100, an output-stage circuit 102, a control module 104, a bootstrap circuit 106 and an upper switch driving circuit 108, for converting an input voltage Vᵢₙ to a stable output voltage Vₒᵤₜ which is lower than the input voltage Vᵢₙ. In detail, the driving-stage circuit 100 includes an upper switch Q1 and a lower switch Q2. The driving-stage circuit 100 controls states of the upper switch Q1 and the lower switch Q2 according to an upper switch control signal V_CTRL_U generated by the upper switch driving circuit 108 and a lower switch control signal V_CTRL_L generated by the control module 104, such that the upper switch Q1 and the lower switch Q2 switch between the on and off states respectively. That is, the upper switch Q1 is enabled and the lower switch Q2 is disabled, and then the upper switch Q1 is disabled and the lower switch Q2 is enabled, so as to generate a switch signal SS on an output terminal X to the output-stage circuit 102. The output-stage circuit 102 includes an inductor L and a capacitor C, coupled between the output terminal X of the driving-stage circuit 100 and a ground terminal V_{gnd}, keeps the inductor L operating between the charge and discharge states according to the switch signal SS transmitted by the driving-stage circuit 100, and maintains the output voltage Vₒᵤₜ with a predefined voltage value by cooperating with the voltage stabilization function of the capacitor C. The bootstrap circuit 106, which is coupled between a bootstrap voltage terminal V_{cc} and the output terminal X of the driving-stage circuit 100, includes a bootstrap capacitor C_BS and a diode D_BS. The bootstrap circuit 106 is used for providing a stable voltage source to the upper switch driving circuit 108.

As can be seen from the above, the control module 104 controls the states of the upper switch Q1 and the lower switch Q2 through the upper switch control signal V_CTRL_U generated by the upper switch driving circuit 108 and the lower switch control signal V_CTRL_L generated by the control module 104, to adjust the switching frequency between the charge and discharge status, so as to generate the desired output voltage Vₒᵤₜ. However, in the DC converter 10, when the voltage difference between the two sides of the bootstrap capacitor C_BS is over-low, the gate-source bias of the upper switch Q1 will be over-low, and the upper switch Q1 may enter into the sub-threshold region and the resistance value of the upper switch Q1 increases, causing the power of the upper switch Q1 to be over-high, such that the upper switch Q1 is damaged. Therefore, the prior art has disclosed that the control module 104 should output the lower switch control signal V_CTRL_L to enable the lower switch Q2 to start charging the bootstrap capacitor C_BS when the voltage difference between the two sides of the bootstrap capacitor C_BS is over-low. However, the cost will increase because accurate and complex detection and logic circuits are required to realize the prior art.

### SUMMARY OF THE INVENTION

It is therefore an objective of the present invention to provide a direct current converter capable of timely controlling charging a bootstrap capacitor without detecting a voltage difference between the two sides of the bootstrap capacitor, so as to keep the voltage difference between the two sides of the bootstrap capacitor at least a specific voltage value.

The present invention discloses a direct current converter for converting an input voltage to an output voltage, the direct current converter includes a driving-stage circuit, including an upper switch and a lower switch, the driving-stage circuit for converting the input voltage to a switch signal according to an upper switch control signal and a lower switch control signal, and transmitting the switch signal through an output terminal, an output-stage circuit, coupled to the output terminal of the driving-stage circuit, for converting the switch signal to the output voltage, a bootstrap circuit, coupled between a bootstrap voltage terminal and the output terminal of the driving-stage circuit, an upper switch driving circuit, coupled to the driving-stage circuit and the bootstrap circuit, for generating the upper switch control signal, and a control module, coupled to the upper switch driving circuit and the lower switch of the driving-stage circuit, for generating the lower switch control signal and controlling the upper switch driving circuit to generate the upper switch control signal according to a first and a second time duration, so as to timely switch a status of the bootstrap circuit to a charge state accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional direct current converter.

FIG. 2 is a schematic diagram of a direct current converter according to an embodiment of the present invention.

### DETAILED DESCRIPTION

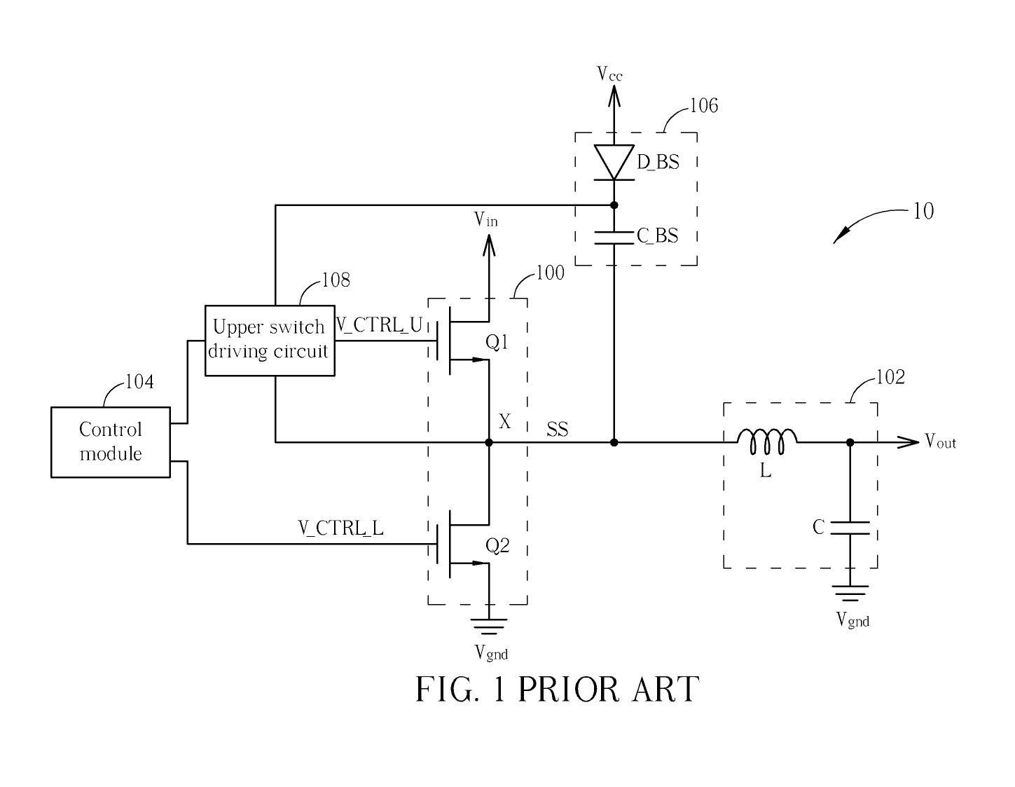

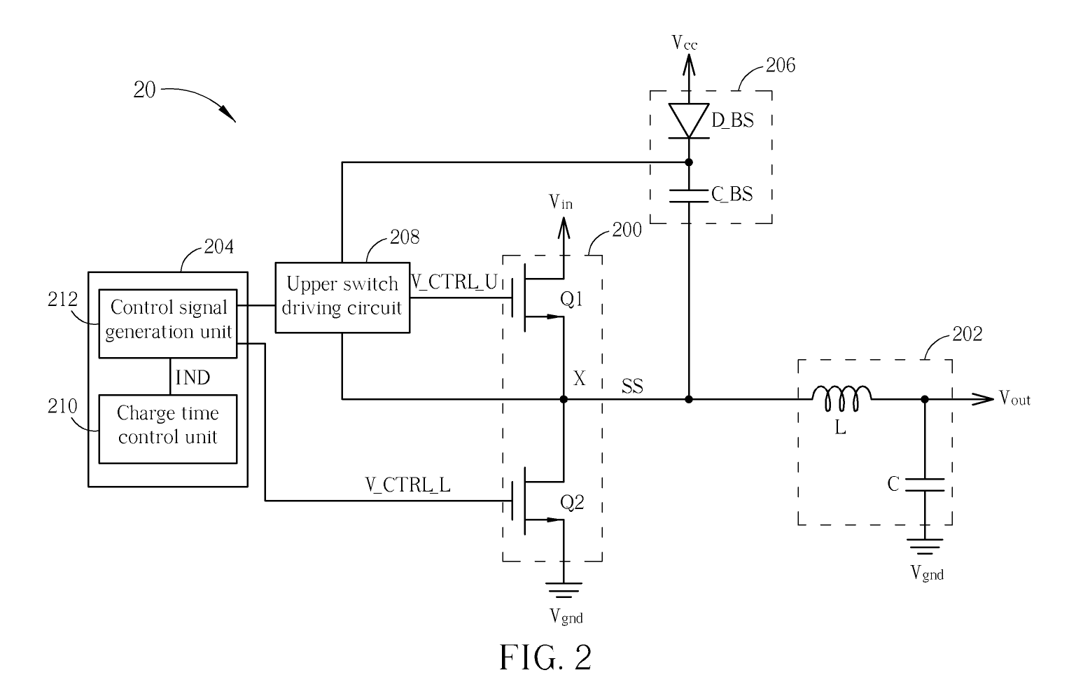

Please refer to FIG. 2, which is a schematic diagram of a direct current (DC) converter 20 according to an embodiment of the present invention. The DC converter 20 includes a driving-stage circuit 200, an output-stage circuit 202, a control module 204, a bootstrap circuit 206 and an upper switch driving circuit 208. By comparing FIG. 2 with FIG. 1, one can know that the driving-stage circuit 200, the output-stage circuit 202, the bootstrap circuit 206 and the upper switch driving circuit 208 of the DC converter 20 are substantially similar to the driving-stage circuit 100, the output-stage circuit 102, the bootstrap circuit 106 and the upper switch driving circuit 108 of the DC converter 10, and the same components are denoted by the same symbols of FIG. 1. The operation of the DC converter 20 is substantially similar to that of the DC converter 10, and is not narrated hereinafter. The difference between the DC converter 20 and the DC converter 10 is that a charge time control unit 210 is added in the control module 204 of the DC converter 20, and operations and realizations of the control module 204 are adjusted correspondingly, so as to timely switch a status of a bootstrap capacitor C_BS to a charge state and avoid damaging the upper switch Q1.

In detail, the control module 204 includes the charge time control unit 210 and a control signal generation unit 212. The charge time control unit 210 sets a time point for switching the bootstrap capacitor C_BS to the charge state and a time duration for charging according to the capacitance of the bootstrap capacitor C_BS, a voltage difference between the two sides of the bootstrap capacitor C_BS, a leakage current of the upper switch Q1 and a charge quantity for the bootstrap capacitor C_BS, and generates an indication signal IND accordingly. The control signal generation unit 212 generates a lower switch control signal V_CTRL_L according to the indication signal IND, and controls the upper switch driving circuit 208 to generate an upper switch control signal V_CTRL_U to control the on and off states of the upper switch Q1 and the lower switch Q2, so as to timely switch the bootstrap capacitor C_BS to the charge state.

The method of setting the time point for switching the bootstrap capacitor C_BS to the charge state and the charge keep time is referred to the following description. The control signal generation unit 212 transmits the lower switch control signal V_CTRL_L to switch the lower switch Q2 to the off state and switch the bootstrap capacitor C_BS to the charge state after a first time duration T_{d1} elapses. The first time duration T_{d1} can be derived from the following equation:

T_{d1}=C_{boot}×ΔV/Iₗₑₐₖ, (Equation 1)

where Iₗₑₐₖ is the leakage current of the upper switch Q1, C_{boot} is the capacitance of bootstrap capacitor C_BS, and ΔV is the difference between a bootstrap voltage V_{cc} and a specific voltage value. In general, the value of Iₗₑₐₖ is approximately between 10 to 100 μA. Since Iₗₑₐₖ, C_{boot}, and ΔV can be predetermined, the first time duration T_{d1} can be pre-derived from Equation 1. Then, the control signal generation unit 212 transmits the lower switch control signal V_CTRL_L to switch the lower switch Q2 to the on state after the first time duration T_{d1} elapses.

Similarly, in the charge state for the bootstrap capacitor C_BS, the time needed for increasing the voltage difference between the two sides of the bootstrap capacitor from the specific voltage value to the bootstrap voltage V_{cc}, which is a second time duration T_{d2} (i.e. the time duration for charging), can also be pre-derived from the capacitance of the bootstrap capacitor C_BS, the voltage difference between the two sides of the bootstrap capacitor C_BS and the charge quantity for the bootstrap capacitor C_BS. The second time duration T_{d2} can be derived from the following equation:

$${T}_{d 2} = \frac{{C}_{boot} \times Δ V}{{I}_{ch}} , \qquad ( Equation 2 )$$

wherein I_{ch} is the charge quantity for the bootstrap capacitor C_BS, C_{boot} is the capacitance of the bootstrap capacitor C_BS, and ΔV is the difference between the bootstrap voltage V_{cc} and the specific voltage value. Since I_{ch}, C_{boot}, and ΔV can be predetermined, the second time duration T_{d2} can be pre-derived from Equation 2. Specifically, the control signal generation unit 212 transmits the lower switch control signal V_CTRL_L to switch the lower switch Q2 to the off state. After the first time duration T_{d1} elapses, the charge time control unit 210 generates an indication signal IND to indicate to the control signal generation unit 212 to transmit the lower switch control signal V_CTRL_L to enable the lower switch Q2, such that the bootstrap capacitor C_BS is entered to the charge state at the time which the bootstrap capacitor C_BS starts charging. In the second time duration T_{d2}, the bootstrap capacitor C_BS is kept in the charge state. The charge time control unit 210 generates the indication signal IND to indicate to the control signal generation unit 212 to generate the lower switch control signal V_CTRL_L to disable the lower switch Q2 after the time duration for charging (i.e. the second time duration T_{d2}) of the bootstrap capacitor C_BS elapses. According to the aforementioned rules, after the first time duration T_{d1} elapses again, the control signal generation unit 212 generates the lower switch control signal V_CTRL_L to enable the lower switch Q2 again and keeps lower switch Q2 in the on state during the second time duration T_{d2}, so as to keep switching the charge state of the bootstrap capacitor C_BS.

In short, in the present invention, the time point for switching the bootstrap capacitor C_BS to the charge state and the time duration for charging are set in advance, and the charge time control unit 210 indicates to the control signal generation unit 212 to generate the lower switch control signal V_CTRL_L according to the first time duration T_{d1} and the second time duration T, and controls the upper switch driving circuit 208 to generate the upper switch control signal V_CTRL_U to switch the upper switch Q1 and the lower switch Q2 between the on and off states, so as to timely switch the bootstrap capacitor C_BS to the charge state.

In the prior art, the charging status of the bootstrap capacitor is determined by detecting the voltage difference between the two sides of the bootstrap capacitor utilizing an extra circuit and comparing the voltage difference between the two sides of the bootstrap capacitor with a reference voltage value. In comparison, in the present invention, the time point for switching the bootstrap capacitor C_BS to the charge state and the time duration for charging can be set in advance according to the characteristics of the components, such that the lower switch timely is switched between the on and off states, for controlling the charge state of the bootstrap capacitor.

To sum up, the DC converter of the present invention can set the time point for charging and the time duration for charging in advance according to the characteristics of the components, so as to timely switch the bootstrap circuit to the charge state without detecting the voltage difference between the two sides of the bootstrap capacitor.

Those skilled in the art will readily observe that numerous modifications and alterations of the device and method may be made while retaining the teachings of the invention. Accordingly, the above disclosure should be construed as limited only by the metes and bounds of the appended claims.

1. A direct current (DC) converter for converting an input voltage to an output voltage, the DC converter comprising:
a driving-stage circuit, comprising an upper switch and a lower switch, the driving-stage circuit for converting the input voltage to a switch signal according to an upper switch control signal and a lower switch control signal, and transmitting the switch signal through an output terminal;
an output-stage circuit, coupled to the output terminal of the driving-stage circuit, for converting the switch signal to the output voltage;
a bootstrap circuit, coupled between a bootstrap voltage terminal and the output terminal of the driving-stage circuit, wherein the bootstrap circuit comprises a diode and a bootstrap capacitor, the diode is coupled to the bootstrap voltage terminal, and the bootstrap capacitor is coupled between the diode and the output terminal of the driving-stage circuit;
an upper switch driving circuit, coupled to the driving-stage circuit and the bootstrap circuit, for generating the upper switch control signal, and
a control module, coupled to the upper switch driving circuit and the lower switch of the driving-stage circuit, for generating the lower switch control signal and controlling the upper switch driving circuit to generate the upper switch control signal according to a first and a second time duration, so as to timely switch a status of the bootstrap circuit to a charge state accordingly, wherein the second time duration is set according to a capacitance of the bootstrap capacitor, a voltage difference between the two sides of the bootstrap capacitor and a charge quantity for the bootstrap capacitor.

2. The DC converter of claim 1, wherein the control module comprises:
a charge time control unit, for generating an indication signal according to the first and the second time duration; and
a control signal generation unit, coupled to the charge time control unit, the upper switch driving circuit and the lower switch of the driving-stage circuit, for generating the lower switch control signal according to the indication signal to control a status of the lower switch, and controlling the upper switch driving circuit to generate the upper switch control signal according to the indication signal to control a status of the upper switch, so as to timely switch the status of the bootstrap circuit.

3. The DC converter of claim 2, wherein generating the lower switch control signal according to the indication signal to control a status of the lower switch is generating the lower switch control signal to switch the status of the lower switch to an on state according to the indication signal after the first time duration elapses.

4. The DC converter of claim 2, wherein generating the lower switch control signal according to the indication signal to control a status of the lower switch is keeping an on state for the lower switch in the second time duration and switching the status of the lower switch to an off state after the second time duration elapses.

5. The DC converter of claim 1, wherein the output-stage circuit comprises an inductor and a capacitor, coupled between the output terminal of the driving-stage circuit and a ground terminal, for transmitting the output voltage through a node between the inductor and the capacitor.

6. (canceled)

7. The DC converter of claim 1, wherein the first time duration is set according to a capacitance of the bootstrap capacitor, a voltage difference between the two sides of the bootstrap capacitor and a leakage current of the upper switch.

8. (canceled)
